(19) United States
(12) Patent Application Publication
(10) Pub. No.: US 2004/0145223 A1
(43) Pub. Date: Jul. 29, 2004

(54) Vehicle seat for preventing a neck injury

(76) Inventor: Keun Bae Lee, Suwon-si (KR)

Correspondence Address: MORGAN, LEWIS & BOCKIUS, LLP., 3300 HILLVIEW AVENUE, PALO ALTO, CA, 94304, US

(21) Appl. No.: 10/646,857

(22) Filed: Aug. 22, 2003

(30) Foreign Application Priority Data
Oct. 12, 2002 (KR) 2002-62242

(51) Int. Cl. B60R 21/055

(52) U.S. Cl. 297/216.12

(57) ABSTRACT

The present invention relates to a vehicle seat capable of effectively preventing a neck injury during a rear-end collision, the vehicle seat comprising a headrest supporting frame whose lower end is secured to a recliner, a seatback frame being elastically connected to said headrest supporting frame by means of elastic means, and a headrest adjusting bar for changing a height of a headrest, which couples the headrest with the headrest supporting frame, whereby the shock applied on the chest of a seat occupant, as well as a neck, can be significantly reduced by decreasing the acceleration of the upper body of the seat occupant.

### FIELD OF THE INVENTION

The present invention relates to a vehicle seat for preventing a neck injury, and more particularly to a vehicle seat comprising a seatback frame that is independently moveable with respect to a headrest supporting frame, whereby the seatback frame only moves backward in the event of a rear-end collision.

### BACKGROUND OF THE INVENTION

In general, a seat of an automobile is composed of a seat cushion, a seatback for supporting the upper body of a seat occupant, and a headrest for supporting a head and a neck of a seat occupant. The seat cushion is conventionally moveable back and forth on a floor panel of an automobile by means of a seat track and a rail. The seatback frame is capable of adjusting the incline with respect to the seat cushion. Moreover, the headrest is generally provided with height adjusting means for changing the height of the headrest.

Based on the above-described fundamental elements, studies for improving safety of a vehicle seat and providing convenient functions with a vehicular seat have been conducted in recent years. As a result, various types of seats provided with a protecting device in the event of a rear-end collision have been developed.

According to statistics, most rear-end collisions lead to neck injuries in seat occupants. Even though there is no specifically regulated equation to determine the degree of a neck injury, NIC (Neck Injury Criterion) defined as following equation has been generally used by many research institutions.

NIC(Neck Injury Criterion)=0.2×a_{—}rel+v_{—}rel

In the above equation, ‘a_rel’ indicates a relative acceleration of the first thoracic spine (T1) with respect to the first cervical spine (C1: atlas). Accordingly, the variable, ‘a_rel’ can be formulated as follows.

a_{—}rel=aT1−aC1

In the same manner, ‘v_rel’ indicating a relative velocity of the first thoracic spine (T1) with respect to the first cervical spine (C1) can be calculated by the following equation.

v_{—}rel=vT1−vC1

As described above, unlike other injury criteria, because the NIC (Neck Injury Criterion) include a velocity factor and an acceleration factor for the upper chest of a seat occupant as well as a velocity factor and an acceleration factor for the neck of a seat occupant, it has been widely used in determining degree of a neck injury.

Various types of vehicle seats having a protecting device in the event of a rear-end collision are disclosed, for example, in U.S. Pat. Nos. 6,478,373, 6,024,406, and 5,645,320. Such vehicle seats can be beneficial in protecting a neck of a seat occupant by decreasing the acceleration of the neck in the event of a rear-end collision. None of those, however, has considered acceleration or velocity applied on the chest of a seat occupant. For example, one of such vehicle seats is disclosed in PCT publication No. WO98/09838.

With the seat disclosed in WO98/09838, in a rear-end collision, the upper body of the seat occupant is flung into the seatback while deforming a resilient foam layer encompassing the seatback frame. When the resilient foam layer is maximally compressed, then the pressure receiving plate installed to the seatback frame pivots upwardly in response to the movement of the seat occupant. Subsequently, the headrest connected to the pressure receiving plate by means of the connecting rod slightly moves forward and safely supports the head or the neck of the seat occupant, so that a neck injury is preferably prevented.

Even though such a seat structure can effectively hold a head of a seat occupant in a safe position in a rear-end collision, it is disadvantageous in that acceleration applied on the chest of the seat occupant during deformation of the foam layer is considerable, which results in increasing NIC (Neck Injury Criterion). Moreover, a bottoming out phenomenon, which occurs when a resilient foam layer is maximally compressed, incurs a sudden increase of acceleration.

There is also another seat structure developed to absorb shock caused by a rear-end collision, which comprises a seatback capable of rotating backwardly within a certain angle by means of an adjustable recliner that releases locking state of the seatback in the event of the rear-end collision. Such a seat structure is advantageous in decreasing the NIC (Neck Injury Criterion) by providing a sufficient shock absorbing space and time. However, not only the mechanism of the seat is complicated, but also the seatback tends to excessively deform in a rear-end impact over 80 km/hour, whereby more serious damage to the seat occupant could arise due to the separation of the seat occupant from the seat.

### SUMMARY OF THE INVENTION

Embodiments of the present invention provide a vehicle seat capable of protecting the upper body of a seat occupant as well as a neck of the seat occupant by separately equipping a headrest supporting frame, the headrest supporting frame being connected to a seatback frame by means of an elastic means.

A preferred embodiment of the present invention comprises a headrest supporting frame whose lower end is secured to a recliner; a seatback frame being elastically connected to said headrest supporting frame; a plurality of elastic connecting means that elastically couple said headrest supporting frame and said seatback frame; and a headrest adjusting bar that adjusts the height of a headrest, the headrest adjusting bar being perpendicularly bent.

In a preferred embodiment of the present invention, the elastic connecting means is a tension spring having sufficient stiffness to solidly support the back of a seat occupant in a normal state.

In another preferred embodiment of the present invention, one end of the headrest adjusting bar is connected to a frame inside the headrest, and the other end of the headrest adjusting bar is adjustably inserted into an inserting hole formed at the upper end of the headrest supporting frame.

In an alternative embodiment of the invention, a vehicle seat comprises a headrest supporting frame, a seatback supporting frame and elastic connectors extending therebetween. The headrest supporting frame is configured at a bottom end for attachment to a seat and at a top end for supporting a headrest. The seatback frame is disposed within the headrest supporting frame, independent from the headrest supporting frame. The seatback frame is configured for carrying a vehicle seatback. The elastic connectors elastically couple the frames together while permitting relative movement therebetween. The elastic connectors may comprise tension springs. Preferably, the headrest supporting frame comprises left and right upright members with an adjustment bar extending therebetween. Adjustment members are mounted atop each upright member to define adjusting holes into which the headrest adjustment bar is adjustably received. The headrest adjustment bar is configured to carry the vehicle seat headrest, so as to be adjustable with respect to the seat.

### BRIEF DESCRIPTION OF THE DRAWINGS

The aforementioned aspects and other features of the present invention will be explained in the following description, taken in conjunction with the accompanying drawings, wherein:

FIG. 1 is a front view of a vehicle seat for preventing a neck injury according to an embodiment of the present invention, in which a resilient foam layer is removed for better understanding of the structure thereof;

FIG. 2 is a perspective view of a vehicle seat for preventing a neck injury according to an embodiment of the present invention;

FIG. 3 is a perspective view showing a movement of a backseat according to an embodiment of the present invention in the event of a rear-end collision;

FIG. 4 is a perspective view of a vehicle seat for preventing a neck injury according to an embodiment of the present invention, in which a resilient foam layer is removed for better understanding of the structure thereof;

FIG. 5 is a perspective view showing a movement of a backseat according to an embodiment of the present invention in the event of a rear-end collision, wherein a resilient foam layer is removed for better understanding of the structure thereof;

FIG. 6 is a graph showing acceleration of a seat occupant' chest in a seat according to an embodiment of the present invention and in a conventional seat during a rear-end collision; and

FIG. 7 is a graph showing a NIC (Neck Injury Criterion) of an embodiment of the present invention and a conventional vehicle seat during a rear-end collision.

### DETAILED DESCRIPTION OF PREFERRED EMBODIMENTS

Hereinafter, a preferred embodiment of the present invention is described in detail with reference to the accompanying drawings.

Considering the NIC equation (Neck Injury Creterion=0.2×a_rel+v_rel), the vehicle seat according to the present invention can effectively prevent a neck injury by reducing ‘v_rel’ (a relative velocity of a chest of a seat occupant with respect to a neck) in such a manner of enlarging a shock-absorbing space of a seat occupant's chest.

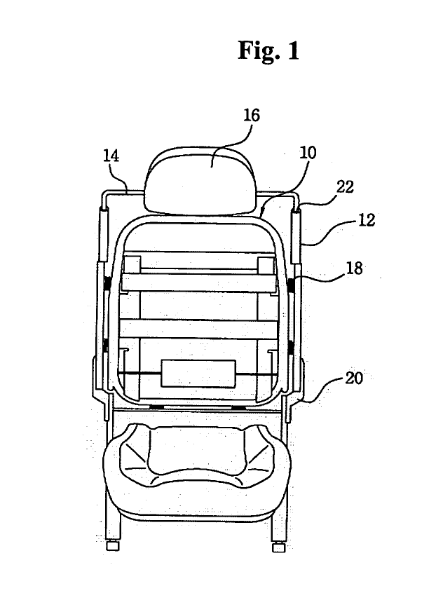

As shown in FIG. 1, a headrest supporting frame 12 is separated from a seatback frame 10, wherein the headrest supporting frame 12 and the seatback frame 10 are elastically coupled by a plurality of elastic connecting means 18. Formed at the upper end of the headrest supporting frame 12 is an adjusting hole 22. The lower end of the headrest supporting frame 12 is secured to a recliner that controls inclination of the seatback 20. The elastic connecting means 18 should have sufficient stiffness so as to solidly support the back of a seat occupant in a normal state. Even though a tension spring is employed as the elastic connecting means in the present embodiment, it is easily appreciated that the tension spring can be substituted with another elastic means having the same characteristic.

In a particularly preferred embodiment, six tension springs are used in coupling a headrest supporting frame 12 with a seatback frame 10, wherein four of those tension springs are installed between the outside of the seatback frame 10 and the inside of the headrest supporting frame 12. The other tension springs elastically couple a bottom part of the seatback frame 10 with a recliner shaft 28.

An embodiment of the present invention further comprises a headrest adjusting bar 14 for changing the height of a headrest 16, of which one end is connected to a frame inside the headrest 16, and the other end is downwardly bent so as to be adjustably inserted into the inserting hole 22 formed at the upper end of the headrest supporting frame 12.

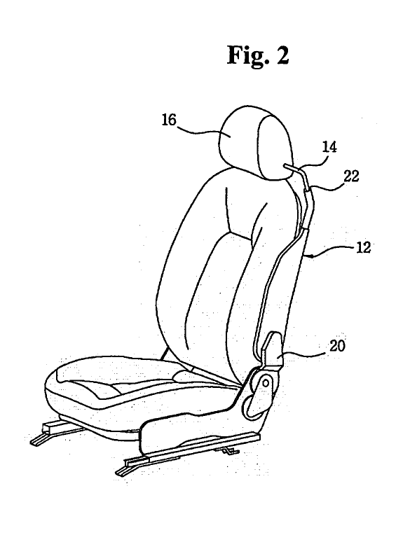

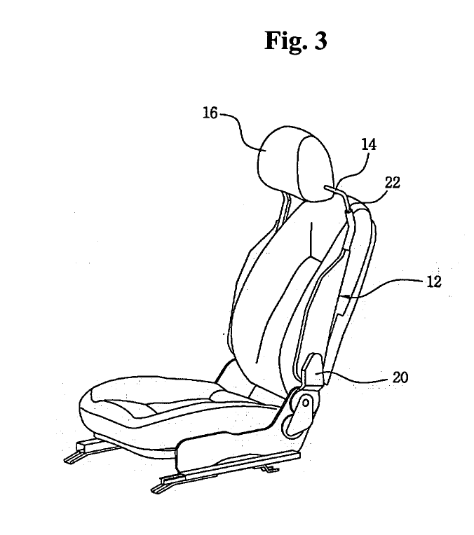

With the aforementioned structure, the seatback frame 10 and the headrest 16 of the embodiment of the present invention can independently move in the event of a rear-end collision. The accompanying FIG. 2 and FIG. 3 show a embodiment of the present invention, which is completed with resilient foam layers and seat covers.

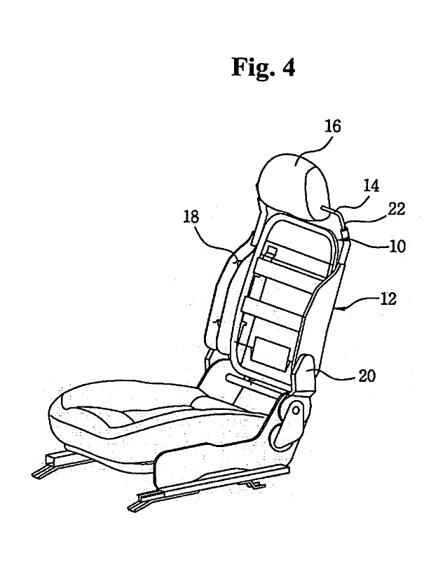

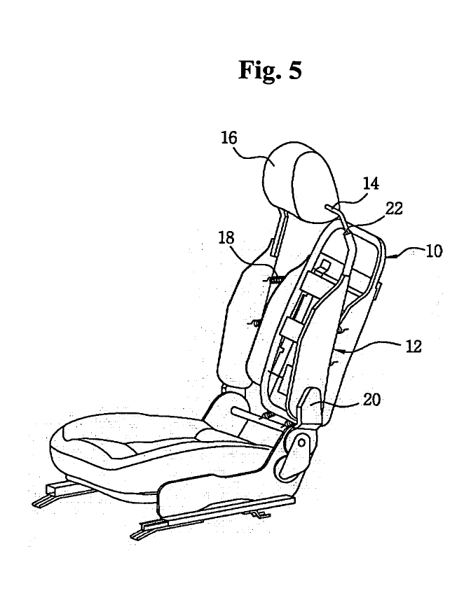

Referring to the accompanying FIGS. 2-5, the operation of an embodiment according to the present invention will be apparent. In an initial state of a seat, shown in FIG. 2 and FIG. 4, when a rear-end impact is applied to the seat, the upper body of a seat occupant is suddenly flung into a seatback while pushing a seatback frame 10 backward due to inertial force. Subsequently, as shown in FIG. 3 and FIG. 5, the seatback frame 10 moves backward with decreasing acceleration by a tension spring 18 of which one end is secured to a fixed headrest supporting frame 12, whereby the shock applied to the chest part of a seat occupant is significantly reduced. At the same time, because a head and a neck of the seat occupant are rigidly supported by a fixed headrest 16, the head and the neck are bent forward with respect to the upper body of the seat occupant, so that an injury due to sudden backward movement of the head is properly prevented. Consequently, the present invention is advantageous in that the shock applied on the chest of a seat occupant can be effectively minimized by ensuring sufficient shock-absorbing space as well as decreasing the acceleration of the seatback by means of a plurality of elastic connecting means.

In the light of NIC (Neck Injury Criterion=0.2×a_rel+v_rel), the present invention can minimize a possibility of a neck injury by reducing a relative acceleration (a_rel) and a relative velocity (v_rel) of the first thoracic spine (T1) with respect to the first cervical spine (C1).

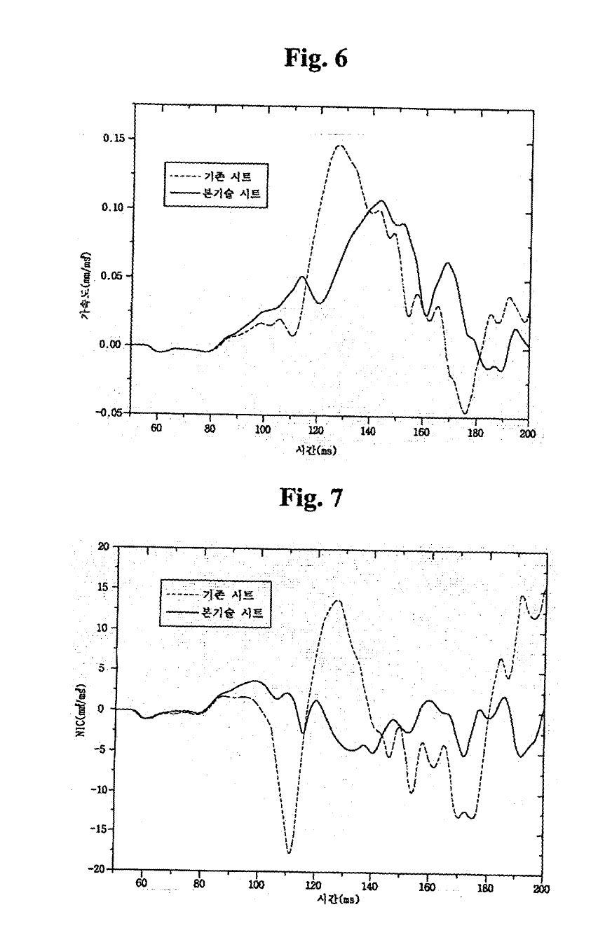

For comparing the performance of the embodiment according to the present invention with a conventional seat structure, the accompanying FIGS. 6 7 graphically show acceleration of a seat occupant's chest and a NIC, respectively. The graphs are based on Dummy simulation in case of a rear-end impact having a speed of 10 km/hour. As seen from FIG. 6 and FIG. 7, it is appreciated that the NIC of the present invention is much lower than that of the conventional seat structure. Moreover, the occurrence of maximum acceleration is rather delayed, which also contributes to significantly reduce the NIC.

Even though the present invention is described in detail with reference to the abvoe embodiment, it is not intended to limit the scope of the present invention. It is evident from the foregoing that many variations and modifications may be made by a person having an ordinary skill in the present filed without departing from the essential concept of the present invention.

What is claimed is:

1. A vehicle seat for preventing a neck injury, the vehicle seat comprising:
a headrest supporting frame having a lower end secured to a recliner and an upper end provided with an insert hole;
a seatback frame elastically connected to said headrest supporting frame so that relative movement with respect to said headrest supporting frame is possible;
a plurality of elastic connecting means that elastically couple said headrest supporting frame and said seatback frame; and,
a headrest adjusting bar that adjusts the height of a headrest, the headrest adjusting bar being perpendicularly bent for connecting to the headrest through the side of the headrest.

2. A vehicle seat according to claim 1, wherein the elastic connecting means is at least one tension spring having a sufficient stiffness to solidly support the back of a seat occupant in a normal state.

3. A vehicle seat according to claim 1, wherein the upper end of the headrest adjusting bar is connected to a frame inside the headrest, and the lower end of the headrest adjusting bar is adjustably inserted into the inserting hole formed at the upper end of the headrest supporting frame.

4. A vehicle seat, comprising:
a headrest supporting frame configured at a bottom end for attachment to a seat and at a top end for supporting a headrest;
a seatback frame disposed within the headrest supporting frame, independent from said headrest supporting frame, the seatback frame being configured for carrying a vehicle seatback; and
elastic connectors extending between said frames to elastically couple said frames together while permitting relative movement therebetween.

5. The vehicle seat of claim 4, wherein said headrest supporting frame comprises:
left and right upright members;
adjustment members mounted atop each upright member to define adjusting holes; and
a headrest adjustment bar received in said holes and extending between said upright members, the headrest adjustment bar being configured to carry a headrest and vertically adjustable with respect to the seat.

6. The vehicle seat of claim 4, wherein said elastic connectors comprise tension springs.
